(19) United States
(12) Patent Application Publication
(10) Pub. No.: US 2013/0093240 A1
(43) Pub. Date: Apr. 18, 2013

(54) CHARGE CONTROLLER AND PORTABLE DEVICE APPLYING THE SAME

(71) Applicants: Yu-Chien Lin, Chupei City (TW); Chun-hsiu Liao, Chupei City (TW); Che-Min Liao, Chupei City (TW)

(72) Inventors: Yu-Chien Lin, Chupei City (TW); Chun-hsiu Liao, Chupei City (TW); Che-Min Liao, Chupei City (TW)

(73) Assignee: FEATURE INTEGRATION TECHNOLOGY INC., Chupei City (TW)

(21) Appl. No.: 13/330,952

(22) Filed: Dec. 20, 2011

(30) Foreign Application Priority Data
Oct. 14, 2011 (TW) 100137342

(51) Int. Cl. H02J 4/00

(52) U.S. Cl. 307/11

(57) ABSTRACT

A charge controller has a printed circuit board (PCB), a first transmission interface, a second transmission interface, and a recognition integrated circuit (IC). The recognition IC of the charge controller recognizes a type of a second electronic device coupled to the second transmission interface, so that a power source of a first electronic device coupled to the first transmission interface in the charge controller is charged in the second electronic device. A portable device applying the charge controller is also described.

### CROSS-REFERENCE TO RELATED APPLICATIONS

This non-provisional application claims priority under 35 U.S.C. §119(a) on Patent Application No(s). 100137342 filed in Taiwan, R.O.C. on Oct. 14, 2011, the entire contents of which are hereby incorporated by reference.

### BACKGROUND

1. Technical Field

The present disclosure relates to a charge controller, and more particularly to charge controller, capable of recognizing a type of an electronic device, so that the electronic device can be charged through a power supply device, therefore, a charging performance is improved to be the same as that of an original manufacturer charger.

2. Related Art

In recent market, many electronic products have fixed chargers, but various chargers easily result in inconvenience in using, and the chargers of the electronic products cannot be shared. For example, for a tablet computer iPad produced by Apple Inc., when iPad is connected to non-apple computer without a special design, the information showing that the charging cannot be performed are displayed. Therefore, iPad may be charged when being connected to an apple computer or by utilizing an original manufacturer charger. Therefore, when having many electronic devices, a user also needs to have various chargers, thereby resulting in the inconvenience in using

In addition, when a universal serial bus (USB) disk or a walk man in the recent market is connected to a computer to transmit data, an electric power from the computer is supplied to the USB disk or the walk man. The USB disk or the walk man cannot be used as a charge interface to charge other electronic products. However, the USB disk, the walk man, or the tablet computer may be connected to the computer by utilizing a USB connection port to transmit the data or acquire the electric power. Therefore, a USB disk or walk man capable of charging various electronic products is one of the developing directions in the field.

In ROC patent No. M397102, a charging device of a computer peripheral device is disclosed. A mouse, a keyboard, a sounder, or another computer peripheral device is used as a power source transmission interface, and is used to charge various electronic devices (for example, a tablet computer, a digital camera, and a walk man). However, not all the computers in the recent mark may be disposed with the mouse, the keyboard, or the sounder capable of supplying the power source. Therefore, the device still limits the convenience of charging the electronic products by the user.

### SUMMARY

In view of the above, the present disclosure is a charge controller and a portable device applying the charge controller, in which the charge controller and the portable device may adapt and input a power source of an electronic device to another electronic device for performing charging.

An embodiment of the present disclosure provides a charge controller, which comprises a printed circuit board (PCB), a first transmission interface, a second transmission interface, and a recognition integrated circuit (IC). The recognition IC is disposed on the PCB, and the recognition IC is coupled between the first transmission interface and the second transmission interface. The first transmission interface is located on one end of the PCD, and the second transmission interface is located on the other end of the PCB. The first transmission interface is used to couple to a first electronic device, and the second transmission interface is used to couple to a second electronic device. When the second transmission interface is coupled to the second electronic device, the recognition IC outputs an adjusting signal as a response according to a type of the second electronic device to adjust a configuration of the second transmission interface, and the second electronic device recognizes the configuration to receive a power source of the first electronic device through the first transmission interface and the second transmission interface.

According to an embodiment of the present disclosure, the adjusting signal output by the recognition IC comprises a positive adjusting potential and a negative adjusting potential.

According to an embodiment of the present disclosure, the configuration of the second transmission interface is a potential difference of the positive adjusting potential and the negative adjusting potential.

According to an embodiment of the present disclosure, the adjusting signal output by the recognition IC is an adjusting instruction, and the adjusting instruction adjusts the configuration of the second transmission interface.

Another embodiment of the present disclosure provides a portable storing device applying the charge controller, in which the portable storing device comprises a first transmission interface, a second transmission interface, a recognition IC, and a functional circuit. The recognition IC is coupled between the first transmission interface and the second transmission interface. The first transmission interface is used to couple to a first electronic device, and the second transmission interface is used to couple to a second electronic device. The functional circuit is coupled to the first transmission interface, and used to execute a predetermined function. When the second transmission interface is coupled to the second electronic device, the recognition IC recognizes a type of the second electronic device and outputs an adjusting signal as a response to adjust a configuration of the second transmission interface, the second electronic device recognizes the configuration to receive a power source of the first electronic device through the first transmission interface and the second transmission interface.

According to another embodiment of the present disclosure, the adjusting signal output by the recognition IC comprises a positive adjusting potential and a negative adjusting potential.

According to another embodiment of the present disclosure, the configuration of the second transmission interface is a potential difference of the positive adjusting potential and the negative adjusting potential.

According to another embodiment of the present disclosure, the adjusting signal output by the recognition IC is an adjusting instruction, and the adjusting instruction adjusts the configuration of the second transmission interface.

According to another embodiment of the present disclosure, the predetermined function executed by the functional circuit is a storing function, an illumination function, a sound recording function, or a function of reading a memory card.

Further another embodiment of the present disclosure provides a charge controller, which comprises a charge connection interface, a transmission interface, and a recognition IC. The recognition IC is coupled between the charge connection interface and the transmission interface. The charge connection interface is used to couple to a charging power source, and the transmission interface is used to couple to an electronic device. When the transmission interface is coupled to the electronic device, the recognition IC outputs an adjusting signal as a response according to a type of the electronic device to adjust a configuration of the transmission interface, the electronic device recognizes the configuration to receive a power source of the charging power source through the charge connection interface and the transmission interface.

According to an embodiment of the present disclosure, the adjusting signal output by the recognition IC comprises a positive adjusting potential and a negative adjusting potential.

According to an embodiment of the present disclosure, the configuration of the second transmission interface is a potential difference of the positive adjusting potential and the negative adjusting potential.

According to an embodiment of the present disclosure, the adjusting signal output by the recognition IC is an adjusting instruction, and the adjusting instruction adjusts the configuration of the second transmission interface.

The present disclosure provides a charge controller and a portable device applying the charge controller. In the charge controller and the portable storing device applying the charge controller according to the present disclosure, a type of an electronic device coupled to a second transmission interface may be recognized. Further, according to types of different electronic devices, different adjusting signals are output as a response to adjust a configuration of the second transmission interface. The electronic device recognizes the configuration of the adjusting signal to accept a power source of another electronic device.

For purposes of summarizing, some aspects, advantages and features of some embodiments of the invention have been described in this summary. Not necessarily all of (or any of) these summarized aspects, advantages or features will be embodied in any particular embodiment of the invention. Some of these summarized aspects, advantages and features and other aspects, advantages and features may become more fully apparent from the following detailed description and the appended claims.

### BRIEF DESCRIPTION OF THE DRAWINGS

The present disclosure will become more fully understood from the detailed description given herein below for illustration only, and thus are not limitative of the present disclosure, and wherein:

FIG. 1 is a block diagram of connection of a charge controller;

FIG. 2 is a block diagram of connection of a portable storing device applying a charge controller;

FIG. 3 shows a vehicle charger applying a charge controller;

FIG. 4 is a structural view of a charge controller; and

FIG. 5 is an operation flow chart of a recognition IC.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

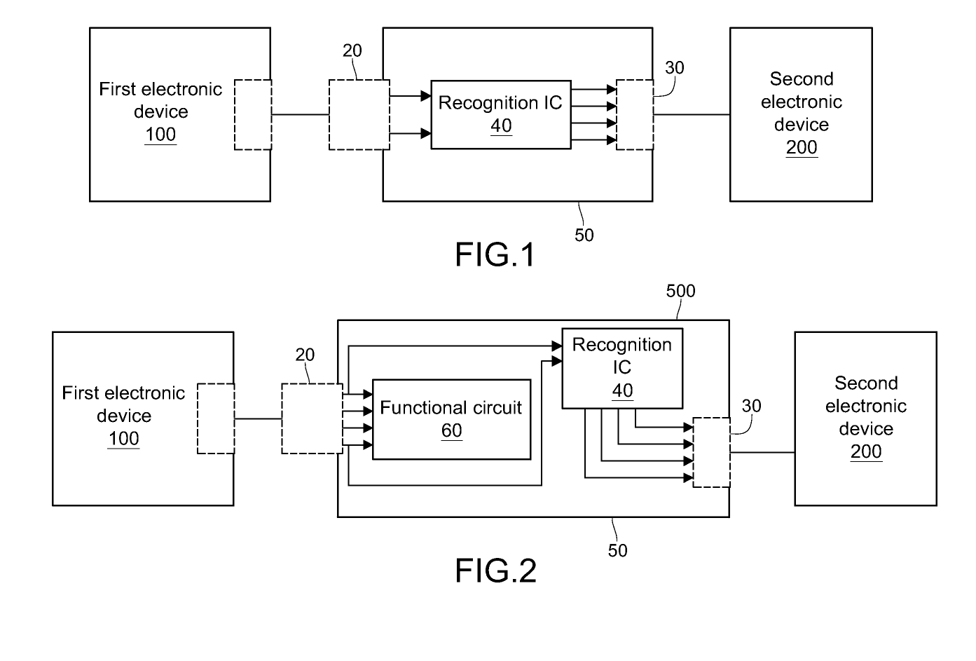

FIG. 1 is a schematic systematic block diagram of a charge controller 50. Referring to FIG. 1, the charge controller 50 comprises a first transmission interface 20, a second transmission interface 30, and a recognition IC 40. The first transmission interface 20 of the charge controller 50 may be used to couple to a first electronic device 100, for example, a desktop computer or a notebook computer, but the present disclosure is not limited hereto. The second transmission interface 30 may be used to couple to a second electronic device 200, usually a portable electronic device, for example, a tablet computer or a walk man, but the present disclosure is not limited hereto. The recognition IC 40 is coupled between the first transmission interface 20 and the second transmission interface 30, the recognition IC 40 may recognize a type of the second electronic device 200 coupled to the second transmission interface 30, and outputs an adjusting signal as a response to adjust a configuration of the second transmission interface 30. The second electronic device 200 recognizes the configuration to receive a power source of the first electronic device 100 through the first transmission interface 20 and the second transmission interface 30, and the second electronic device 200 may be charged by utilizing the power source.

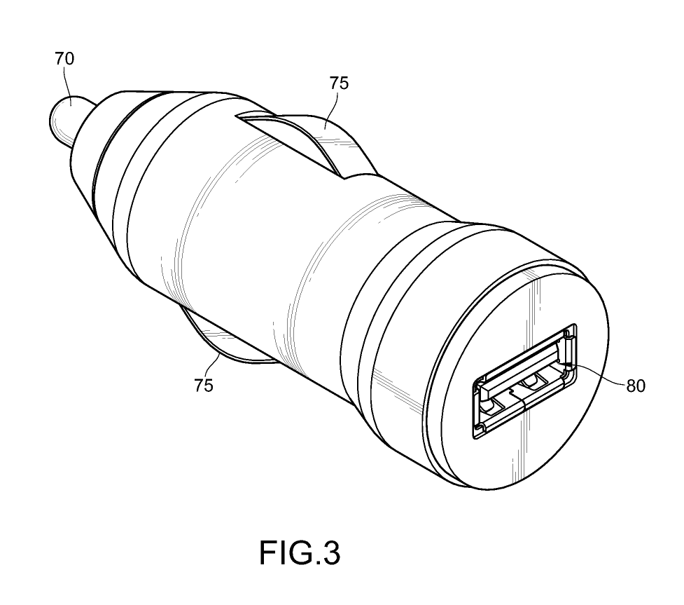

Referring to FIG. 2, it is a schematic systematic block diagram of a portable device applying the charge controller 50 of FIG. 1. Numerals of FIG. 2 being the same as that of FIG. 2 represent the same or similar structure and coupling relation, and description is not given in the following. The greatest difference between FIG. 2 and FIG. 1 is that FIG. 2 further has a functional circuit coupled to a first transmission interface, in which the functional circuit may be used to execute a predetermined function. For example, the functional circuit may be a circuit having a storing function, a circuit having an illumination function, a circuit having a sound recording function, or a circuit having a reading function. The functional circuit may be adjusted according to practical application states, and the predetermined function executed by the functional circuit in this embodiment is, for example, the storing function, for description. As shown of FIG. 2, the portable device of FIG. 2 may be a portable storing device 500. The portable storing device 500 has a first transmission interface 20, a second transmission interface 30, a recognition IC 40, and a functional circuit 60. The functional circuit 60 has a non-volatile memory (not shown) capable of being coupled to the first transmission interface 20, and used to transmit digital data to a first electronic device 100 coupled to the first transmission interface 20. Meanwhile, the second transmission interface 30 of the portable storing device 500 may be coupled to a second electronic device 200. The recognition IC 40 is coupled between the first transmission interface 20 and the second transmission interface 30. The recognition IC 40 may recognize a type of the second electronic device 200 and outputs an adjusting signal as a response to adjust a configuration of the second transmission interface 30, the second electronic device 200 may recognize the configuration to receive a power source of the first electronic device 100 through the first transmission interface 20 and the second transmission interface 30, and the second electronic device 200 may be charged by utilizing the power source.

In other embodiments, the predetermined function of the functional circuit may be the reading function, for example, the functional circuit may be a functional circuit capable of reading a memory card. The functional circuit may convert a memory card transmission interface to the first transmission interface 20. For example, the memory card transmission interface satisfies a transmission specification of a secure digital (SD) card, a mini SD card, or a micro SD card. Alternatively, in other embodiments, the predetermined function of the functional circuit may be the sound recording function, for example, the functional circuit may be a functional circuit of a sound recording pen, and the functional circuit has a sound source input interface. Alternatively, in other embodiments, the predetermined function of the functional circuit may also be the illumination function. The functional circuit having the illumination function may be a lower power driving light-emitting element, for example, a functional circuit having a light-emitting diode (LED).

Next, referring to FIG. 3, it shows another implementation aspect of the charge controller of FIG. 1. Numerals of FIG. 3 being the same as that of FIG. 1 represent the same or similar structure and coupling relation, and description is not given in the following. The greatest difference between FIG. 3 and FIG. 1 is that the first transmission interface 20 of FIG. 1 is changed to a charge connection interface 70 of FIG. 3, in which the charge connection interface 70 is used to couple to a charging power source. The charging power source may be from a power source socket on a vehicle, but the present disclosure is not limited hereto, and the charging power source may be from a power source socket from any transportation facility, for example, the charge connection interface 70 coupled to the vehicle, as shown in the drawing, and the charge controller coupled to the vehicle is a vehicle charger. A charge interface of the vehicle charger further has two grounding metal sheets 75 located on two sides of the vehicle charger. In addition, the vehicle charger also has a transmission interface 80 and a recognition IC (not shown). The transmission interface 80 is similar to the second transmission interface 30 of FIG. 1. The transmission interface 80 may be a USB connector, a mini USB connector, a micro USB connector, or an Institute of Electrical & Electronic Engineers (IEEE) 1394 connector, but the present disclosure is not limited hereto, the transmission interface 80 may also be other equivalent devices capable of transmitting data and power source. Further, the transmission interface 80 is not limited to be a plug or receptacle connector, for example, in this embodiment, the transmission interface 80 is a receptacle connection interface. The recognition IC may be coupled between the charge connection interface 70 and the transmission interface 80. The recognition IC may recognize a type of an electronic device and outputs an adjusting signal as a response to adjust a configuration of the transmission interface 80, the electronic device may recognize the configuration to receive a power source of the vehicle through the charge connection interface 70 and the transmission interface 80, and the electronic device may be charged by utilizing the power source, in which the electronic device is the second electronic device 200 of FIG. 1.

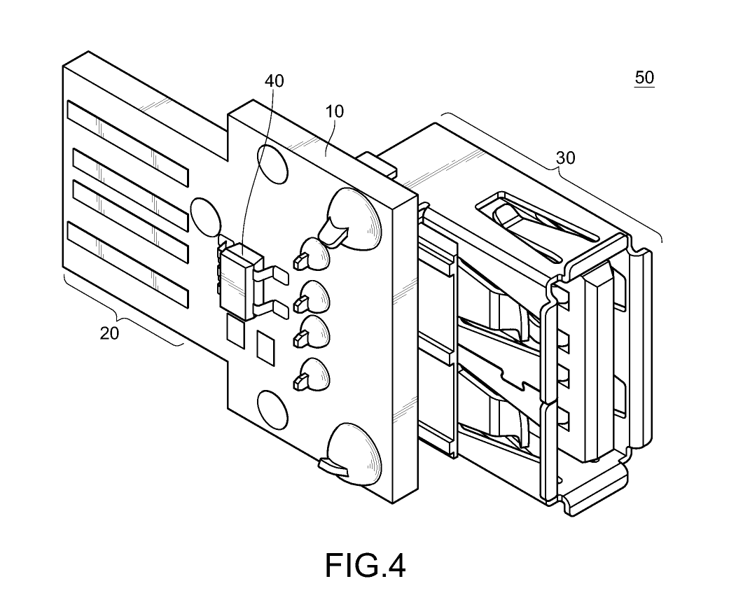

FIG. 4 is a structural view of the charge control of FIG. 1, FIG. 2, and FIG. 3. The charge controller 50 comprises a PCB 10, a first transmission interface 20, a second transmission interface 30, and a recognition IC 40. The recognition IC 40 is disposed on the PCB 10, and the recognition IC 40 is coupled between the first transmission interface 20 and the second transmission interface 30. The first transmission interface 20 may be located on one end of the PCB 10, and the second transmission interface 30 may be located on the other end of the PCB 10, but the present disclosure is not limited hereto. The first transmission interface 20 and the second transmission interface 30 may also be located on two neighboring ends of the PCB 10, in which the first transmission interface 20 may be a USB connector, a mini USB connector, a micro USB connector, or an IEEE 1394 connector, but the present disclosure is not limited hereto, the first transmission interface 20 may also be other equivalent devices capable of transmitting data and power source. The first transmission interface 20 is not limited to be a plug or receptacle transmitter, for example, in this embodiment, the first transmission interface 20 is a plug USB connector. The second transmission interface 30 may be a USB connector, a mini USB connector, a micro USB connector, or an IEEE 1394 connector, but the present disclosure is not limited hereto, the second transmission interface 30 may also be other equivalent devices capable of transmitting data and power source. The second transmission interface 30 is not limited to be a plug or receptacle transmitter, for example, in this embodiment, the second transmission interface 30 is a receptacle USB connector.

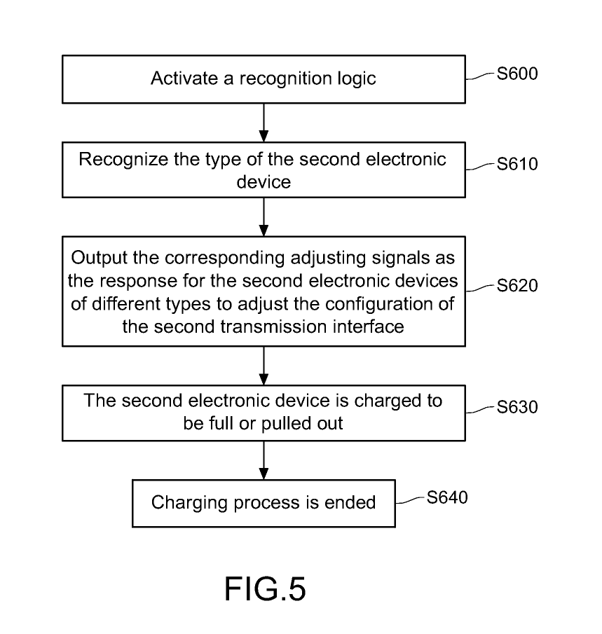

FIG. 5 is an operation flow chart of the recognition IC 40 of FIG. 1 to FIG. 4, in which the operation flow chart comprises a plurality of steps. Taking the charge controller 50 of FIG. 1 and the portable storing device 500 of FIG. 2 as an example, the first transmission interface 20 is coupled to the first electronic device 100, and the second transmission interface 30 is coupled to a second electronic device 200. The recognition IC 40 activates a recognition logic (Step S600), in which the recognition logic may be used to recognize the type of the second electronic device 200 (Step S610). After determining the type of the second electronic device 200, the recognition IC 40 outputs the corresponding adjusting signals as the response for the second electronic devices of different types to adjust the configuration of the second transmission interface 30 (Step S620). In the explanation of the operation flow chart as follows, the second electronic device 200 is, for example, a tablet computer ipad produced by Apple Inc., but the present disclosure is not limited therefore. When iPad is inserted to the second transmission interface 30, the recognition IC 40 activates Step S600 to start to recognize the type of the second electronic device 200 (Step S610). If the type is iPad, the recognition IC 40 activates Step S620 to output an adjusting signal as the response to the second transmission interface 30. In this embodiment, the second transmission interface is, for example, a USB connector, but the present disclosure is not limited hereto, the second transmission interface may also be a mini USB connector, a micro USB connector, or an IEEE 1394 connector, or other equivalent devices capable of transmitting data and power source. A common USB connector has a plurality of metal end points, in which at least two of them are respectively a first signal transmission line and a second signal transmission line. When recognizing that the second electronic device 200 is iPad, the recognition IC activates Step S620 to output the adjusting signal, in which the adjusting signal comprises a positive adjusting potential D+ and a negative adjusting potential D−. The positive adjusting potential D+ may be input to the first signal transmission line, and the negative adjusting potential D− may be input to the second signal transmission line. iPad may discriminate the intensity of the positive adjusting potential D+ and the intensity of the negative adjusting potential D− to activate a charge mode. The charge mode may drive iPad to receive the power source of the first electronic device 100 through the first transmission interface 20 and the second transmission interface 30.

In addition to performing discrimination by utilizing the intensity of the positive adjusting potential D+ and the intensity of the negative adjusting potential D−, certain portable devices may also perform discrimination by utilizing a potential difference of the positive adjusting potential D+ of the first transmission line and the negative adjusting potential D− of the second transmission line in the USB connector. When successfully discriminating the potential difference, the portable devices may receive the power source of the first electronic device 100 through the first transmission interface 20 and the second transmission interface 30. The intensity of the positive adjusting potential D+, the intensity of the negative adjusting potential D−, and the potential difference of the positive adjusting potential D+ and the negative adjusting potential D− may be considered as a configuration of the USB connector. Different intensities of the positive adjusting potential D+, different intensities of the negative adjusting potential D−, and different potential differences of the positive adjusting potential D+ and the negative adjusting potential D− may be considered as different configurations of the USB connector. When being connected to the USB connector, the portable device discriminates the configuration to receive an electric power or digital data transferred through the USB connector. However, aspects of the configuration of the present disclosure are not limited therefore, for example, the adjusting signal output by the recognition IC 40 may comprise an adjusting instruction, and the adjusting instruction may directly adjust the configuration of the second transmission interface, so that the second electronic device 200 discriminates the configuration to receive the electric power or digital data transferred through the USB connector. Alternatively, the adjusting instruction may directly enable the second electronic device 200 to accept the electric power transferred through the USB connector according to the adjusting instruction, for example, the adjusting instruction may be a transmission protocol.

Referring to FIG. 5, if the inserted second electronic device 200 is not iPad, the recognition IC 40 continues performing recognizing. For example, here the recognition IC 40 continues recognizing whether the second electronic device 200 is a charge specification BC1.2 specified by a USB implementers forum (USB-IF). If the second electronic device 200 is the charge configuration BC1.2, the recognition IC 40 outputs an adjusting signal to adjust the configuration of the USB connector to be the BC1.2 configuration. Here, the second electronic device 200 starts to receive the power source of the first electronic device 100 through the first transmission interface 20 and the second transmission interface 30. Referring to FIG. 5, if the inserted second electronic device 200 is not iPad, and the charge specification is not BC1.2, here, the recognition IC 40 starts to recognize whether the second electronic device is another known device built in the recognition IC 40 in addition to the above mentioned two types. If the second electronic device is another known device, the recognition IC 40 outputs the corresponding adjusting signal to change the USB connector to the corresponding configuration. The second electronic device 200 inserted to the USB connector may receive the power source through the first transmission interface 20 and the second transmission interface 30. Finally, when the second electronic device 200 is charged to be full or pulled out (Step S630), the recognition IC 40 stops outputting the adjusting signal as the response, and the entire charging process is ended (Step S640). Although in the above description, the specific transmission interface, iPad with the specific brand, and the specific charge specification BC1.2 are used for description, the present disclosure is not limited to the specific interface, the brand, and the charging specification.

The present disclosure provides a charge controller, capable of changing a configuration of a second transmission interface through a recognition IC disposed therein, so that a power source of a first electric device coupled to a first transmission interface may be charged to the second electronic device coupled to a second transmission interface. The present disclosure further provides a portable device, in which in addition to functions of an original portable device, since having the charge controller, the charge controller further has a function of charging the power of the first electronic device coupled to the first transmission interface to the second electronic device coupled to the second transmission interface.

The present disclosure may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A charge controller, comprising:
a printed circuit board (PCB);
a first transmission interface, located on one end of the PCB;
a second transmission interface, located on the other end of the PCB; and
a recognition integrated circuit (IC), disposed on the PCB, and coupled between the first transmission interface and the second transmission interface,
wherein the first transmission interface is used to couple to a first electronic device, the second transmission interface is used to couple to a second electronic device, when the second transmission interface is coupled to the second electronic device, the recognition IC recognizes a type of the second electronic device and outputs an adjusting signal as a response to adjust a configuration of the second transmission interface, and the second electronic device recognizes the configuration to receive a power source of the first electronic device through the first transmission interface and the second transmission interface.

2. The charge controller according to claim 1, wherein the adjusting signal output by the recognition IC comprises a positive adjusting potential and a negative adjusting potential.

3. The charge controller according to claim 2, wherein the configuration of the second transmission interface is a potential difference of the positive adjusting potential and the negative adjusting potential.

4. The charge controller according to claim 1, wherein the adjusting signal output by the recognition IC is an adjusting instruction, and the adjusting instruction adjusts the configuration of the second transmission interface.

5. The charge controller according to claim 1, wherein the first transmission interface is a plug connector, and the second transmission interface is a receptacle connector.

6. A charge controller, comprising:
a first transmission interface;
a second transmission interface; and
a recognition integrated circuit (IC), coupled between the first transmission interface and the second transmission interface,
wherein the first transmission interface is used to couple to a first electronic device, the second transmission interface is used to couple to a second electronic device, when the second transmission interface is coupled to the second electronic device, the recognition IC recognizes a type of the second electronic device and outputs an adjusting signal as a response to adjust a configuration of the second transmission interface, the second electronic device recognizes the configuration to receive a power source of the first electronic device through the first transmission interface and the second transmission interface.

7. The charge controller according to claim 6, wherein the adjusting signal output by the recognition IC comprises a positive adjusting potential and a negative adjusting potential.

8. The charge controller according to claim 7, wherein the configuration of the second transmission interface is a potential difference of the positive adjusting potential and the negative adjusting potential.

9. The charge controller according to claim 6, wherein the adjusting signal output by the recognition IC is an adjusting instruction, and the adjusting instruction adjusts the configuration of the second transmission interface.

10. The charge controller according to claim 6, wherein the first transmission interface is a plug connector, and the second transmission interface is a receptacle connector.

11. A portable device, comprising:
a first transmission interface;
a second transmission interface;
an recognition integrated circuit (IC), coupled between the first transmission interface and the second transmission interface; and
a functional circuit, coupled to the first transmission interface, and used to execute a predetermined function,
wherein the first transmission interface is used to couple to a first electronic device, the second transmission interface is used to couple to a second electronic device, when the second transmission interface is coupled to the second electronic device, the recognition IC recognizes a type of the second electronic device and outputs an adjusting signal as a response to adjust a configuration of the second transmission interface, and the second electronic device recognizes the configuration to receive a power source of the first electronic device through the first transmission interface and the second transmission interface.

12. The portable device according to claim 11, wherein the adjusting signal output by the recognition IC comprises a positive adjusting potential and a negative adjusting potential.

13. The portable device according to claim 12, wherein the configuration of the second transmission interface is a potential difference of the positive adjusting potential and the negative adjusting potential.

14. The portable device according to claim 11, wherein the adjusting signal output by the recognition IC is an adjusting instruction, and the adjusting instruction adjusts the configuration of the second transmission interface.

15. The portable device according to claim 11, wherein the first transmission interface is a plug connector, and the second transmission interface of the charge controller is a receptacle connector.

16. The portable device according to claim 11, wherein the predetermined function executed by the functional circuit is a storing function.

17. The portable device according to claim 11, wherein the predetermined function executed by the functional circuit is a function of converting a memory card transmission interface to the first transmission interface.

18. The portable device according to claim 11, wherein the predetermined function executed by the functional circuit is an illumination function.

19. The portable device according to claim 11, wherein the predetermined function executed by the functional circuit is a sound recording function.

20. A charge controller, comprising:
a charge connection interface;
a transmission interface; and
a recognition integrated circuit (IC), coupled between the first transmission interface and the second transmission interface,
wherein the charge connection interface is used to couple to a charging power source, the transmission interface is used to couple to an electronic device, when the transmission interface is coupled to the electronic device, the recognition IC recognizes a type of the electronic device and outputs an adjusting signal as a response to adjust a configuration of the transmission interface, the electronic device recognizes the configuration to receive a power source of the charging power source through the charge connection interface and the transmission interface.

21. The charge controller according to claim 20, wherein the adjusting signal output by the recognition IC comprises a positive adjusting potential and a negative adjusting potential.

22. The charge controller according to claim 21, wherein the configuration of the transmission interface is a potential difference of the positive adjusting potential and the negative adjusting potential.

23. The charge controller according to claim 20, wherein the adjusting signal output by the recognition IC is an adjusting instruction, and the adjusting instruction adjusts the configuration of the transmission interface.

24. The charge controller according to claim 20, wherein the transmission interface is a receptacle connector.
